(19) United States
(12) Patent Application Publication
(10) Pub. No.: US 2019/0153997 A1
(43) Pub. Date: May 23, 2019

(54) SYSTEM FOR CONVERTING ENERGY FROM FLOWING MEDIA

(71) Applicant: Ecoligent, LLC, Lancaster, PA (US)

(72) Inventors: Richard Hermann Voegeli, Kuesnacht (CH); Klaus Petrasch, Schmoelln-Putzkau (DE); Gabriel Pausch, Lausitz (DE)

(73) Assignee: Ecoligent, LLC, Lancaster, PA (US)

(21) Appl. No.: 15/816,364

(22) Filed: Nov. 17, 2017

(51) Int. Cl. F03D 3/06

(52) U.S. Cl. CPC F03D 3/065; F03D 3/005

(57) ABSTRACT

The system for converting energy from flowing media with a rotor, in particular with an H-Darrieus rotor, comprising rotor blades made of a fibre-reinforced plastic profile manufactured in an injection moulding process, whereby the fibres of the plastic profile are carbon fibres and/or where the plastic is a thermoplastic material. The rotor blades of H-Darrieus rotor are connected to a shaft by means of radial struts and/or by means of diagonal struts and rotor blade connection components are arranged between the respective rotor blade and the radial struts and/or diagonal struts as a connection. Das rotor blade connection component comprises an enclosing element around at least part of the profile of the rotor blade and a corresponding connection element for the respective radial strut and/or diagonal strut.

### FIELD OF THE INVENTION

This invention relates to a system for converting energy from flowing media, in particular to an H-Darrieus rotor for harnessing wind power.

### BACKGROUND

Different system versions for converting energy from flowing media are known. The systems for converting energy from flowing media relevant to this invention are in particular systems with large rotors, such as wind power systems, as well as systems that make use of tidal currents. A need exists for a novel system for converting energy from flowing media having a lightweight and rigid rotor.

### BRIEF SUMMARY OF THE INVENTION

A system for converting energy from flowing media with a rotor is provided. The task of this invention is to provide a lightweight and rigid rotor for a system for converting energy from flowing media. In particular, the solution should make it possible to build a preferred H-Darrieus rotor. The rotor comprises rotor blades made of fibre-reinforced plastic, manufactured using an injection moulding process. Preferably, carbon fibres embedded in thermoplastic are used as these strengthening reinforcement fibres.

In accordance with the preferred form of use for this invention in an H-Darrieus rotor with radial and diagonal struts, a corresponding rotor blade connection component is provided to connect the radial and/or diagonal struts with their respective rotor blades.

The rotor blade connection component comprises an element that encloses the profile of the rotor blade and a corresponding connection element with each radial strut and/or diagonal strut.

The preferred application is a wind power system with an H-Darrieus rotor. Large H-Darrieus rotors should weigh as little as possible. Large forces should be absorbed with minimal deflection of the rotor blades. To achieve this, the rotor blades must have an optimum aerodynamic profile. The profiles of known H-Darrieus rotors comprise, for example, fibre-reinforced plastic or aluminium. Larger H-Darrieus rotors are secured to the shaft with several radial struts and are also strengthened with diagonal braces and/or diagonal struts.

The task of this invention is to provide a lightweight and rigid rotor for a system for converting energy from flowing media. In particular, this solution should make it possible to embody a corresponding and advantageous H-Darrieus rotor.

The task of this invention is solved with the features of the main claim. The system for converting energy from flowing media comprises a rotor. In accordance with this invention, the rotor blades comprise a plastic profile manufactured using an injection moulding process. The injection moulding process is also called a pultrusion process. The rotor blade profile manufactured using an injection moulding process is able to maintain a consistent optimum shape through the use of a continuous manufacturing process. The fibres used in particular to absorb the tensile forces are embedded during continuous production in the plastic matrix.

The use of materials is optimised, which makes it possible to minimise the weight of the rotor blade while maximising the mechanical properties. Correspondingly large rotor blades can therefore be produced. The internal stabilisation structures such as, for example, struts, can be integrated in the rotor blade during the continuous production process.

Further advantageous embodiments of the invention in accordance with the main claim are disclosed in the sub-claims. In accordance with a further embodiment of the invention, these fibres in the plastic profile are carbon fibres and/or the plastic is a thermoplastic material. This composite material is characterised by a high level of endurance strength in response to repeated load duty cycles. At the same time, the weight of the rotor can be further reduced, which in overall terms reduces the mechanical loads applied to the system. Carbon fibres are available in long lengths and therefore facilitate continuous manufacturing in the pultrusion process. The thermoplastic material can be directed into the production process continuously through a heating unit.

The task of this invention is also solved by means of the features of the subordinated third claim. In accordance with the preferred use of the invention in an H-Darrieus rotor with radial and diagonal struts, a corresponding rotor blade connection component is provided to connect the radial and/or diagonal struts to the relevant rotor blade.

This rotor blade connection component comprises an element that surrounds the profile of the rotor blade and a corresponding connection element for each respective radial strut and/or diagonal strut.

Due to the fact that the enclosing element described in this invention is guided at least partially around the profile of the rotor blade, it is not necessary to provide the rotor blade with bores to hold corresponding retaining elements such as screws or bolts. The enclosing element therefore prevents the rotor blade from being weakened by the incorporation of bores. The reinforcing fibres in the rotor blade can be guided in an optimum manner. This makes the lightweight build of the rotor in accordance with claims 1 and 2, combined with great endurance strength, possible. The enclosing element around the rotor blade connection component can simply be pushed over the rotor blade, which makes it easy to install. For connection with the radial struts and/or diagonal struts, a corresponding connection element is attached, which can be an adapter element, connecting to each respective radial strut and/or diagonal strut. This means that a positive connection can be achieved by plugging the radial strut and/or diagonal strut into or onto the adapter element. This positive connection dissipates the forces introduced by means of the rotor blade through the adapter element and onto the radial and/or diagonal struts. This assures great rigidity in the connection and a high level of geometric integrity in the rotor. This geometric integrity counteracts resonance vibrations from the rotor. Only the tensile forces exerted on the struts need to be directed away in a different manner.

For this, in accordance with an advantageous further embodiment of the invention, the radial struts and/or the diagonal struts can be attached to the connection element axially by means of screw connections. This causes the tensile forces, in particular those arising from the centrifugal forces created by rotational movement, to be exerted on the screws as shearing forces. The connection is easy to manufacture, it is inexpensive and it is easy to repair.

In accordance with a further embodiment of the invention, a cavity is arranged to accommodate a spacer element, located between the enclosing element and the rotor blade. This cavity prevents any direct contact between the surface of the rotor blade and the preferably metallic element enclosing the rotor blade connection component. This cavity, and by extension the spacer element, can help to compensate for any production tolerance issues between the rotor blade and its enclosing element. This simplifies the task of installing the enclosing element on the rotor blade, which is a simple push-on process. This avoids damage to the rotor blade.

In accordance with an advantageous embodiment of the invention, the spacer element is incorporated in the cavity by means of a moulding process. Moulding of the cavity, for example with epoxy resin, enables it to compensate for production tolerances. At the same time, this moulding process can achieve an adhesive bonding action and therefore the enclosing element is able to absorb axial forces. Through this close direct contact between spacer element and rotor blade, the forces acting on the rotor blade are distributed more evenly.

In accordance with an advantageous embodiment of the invention, a first positioning groove is arranged or disposed in the enclosing element to hold or support the profile lug and a second positioning groove is arranged or disposed in the enclosing element to hold the rear edge of the profile. These positioning grooves enable the rotor profile to be secured in position, and therefore for the desired deployment angle of the rotor blade profile to be aligned simply by means of the positioning grooves. These grooves, compatible with the rotor blade profile, therefore act as a gauge and simplify the assembly process.

In accordance with one embodiment of the invention, the radial struts and/or the diagonal struts each comprise aerodynamic profiles. Aerodynamic profiles, such as a National Advisory Committee for Aeronautics (NACA) airfoil, reduce air friction, which increases the efficiency rating of the energy conversion system. The adapter elements can be adapted to suit any shape of the struts, and therefore to suit the aerodynamic shape of each profile.

In accordance with a further embodiment of the invention, the rotor blade connection component consists or is made of metal including metal alloys, in particular of steel or aluminium. Metals have good processing characteristics and great strength. They can be bent, drilled and welded. Steel connection components on rotor blades can be galvanised to inhibit corrosion. Aluminium connection components on rotor blades help to reduce the weight of the rotor.

In accordance with a preferred embodiment of the invention the rotor blade connection component and the rotor blade as well as the struts in this area are contained within a plastic enclosure, preferably manufactured using a moulding die.

Furthermore, the invention task can be solved by integrating the rotor bearing in a driving work machine, whereby generator and rotor share a common shaft. The driving work machine is most commonly a generator. It is also possible for the rotor for example to be connected to a pump in which the rotor bearing is integrated. With correspondingly dimensioned bearings of the work machine, no separate bearings are required for the rotor. This simplifies the design of the rotor and therefore correspondingly simplifies the design of the wind power system.

In accordance with a further embodiment of the invention the driving work machine is provided with a flange and with a corresponding tower flange that is connected to that flange. This enables the rotor to be connected to the tower via the generator. At the same time, the generator can be integrated in a tubular tower, protecting it against prevailing weather conditions.

### BRIEF DESCRIPTION OF THE DRAWINGS

Some embodiments of the present invention are illustrated as an example and are not limited by the figures of the accompanying drawings, in which like references may indicate similar elements and in which:

FIG. 1a-FIG. 1a depicts a perspective view of a rotor blade connection component according to various embodiments described herein.

FIG. 1b-FIG. 1b illustrates sectional view through a rotor blade with rotor blade connection component according to various embodiments described herein.

FIG. 2-FIG. 2 depicts a perspective view of a rotor blade connection component with plastic enclosure according to various embodiments described herein.

FIG. 3-FIG. 3 shows a perspective view of a rotor blade connection component with plastic enclosure as well as rotor blade, radial strut and diagonal strut according to various embodiments described herein.

FIG. 4-FIG. 4 depicts a rotor blade connection component in an assembly view according to various embodiments described herein.

FIG. 5-FIG. 5 illustrates a perspective view of a rotor blade connection component with plastic enclosure according to various embodiments described herein.

FIG. 6-FIG. 6 shows an H-Darrieus rotor according to various embodiments described herein.

FIG. 7-FIG. 7 depicts a generator with integrated rotor shaft mounting according to various embodiments described herein.

### SUMMARY OF THE REFERENCE CHARACTERS

1—rotor blade
2—radial strut
3—diagonal strut
4—shaft, rotor shaft
5—rotor blade connection component
6—enclosing element,
7—enclosing element
8a, 8b—connection element, adapter element
9—spacer element
10—first positioning groove
11—profile lug
12—second positioning groove
13—enclosure, plastic enclosure
14—screw connections
15—bearing, rotor shaft mounting
16—work machine, generator
17—flange
18—tower flange
19—caps
20—shaft connection component
21—tower A—connection between rotor blade and radial strut
B—rotor blade connection with radial strut and diagonal strut
C—rotor blade connection with diagonal strut

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

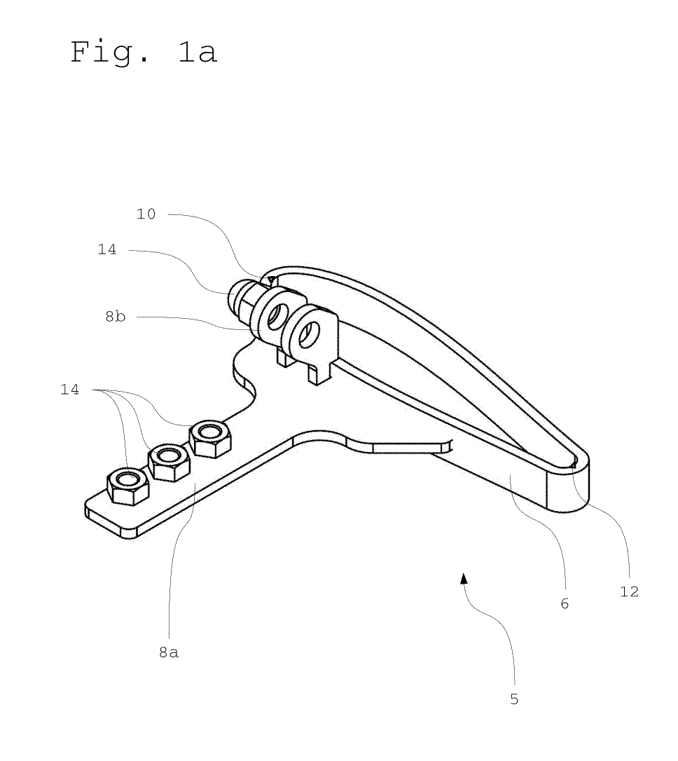

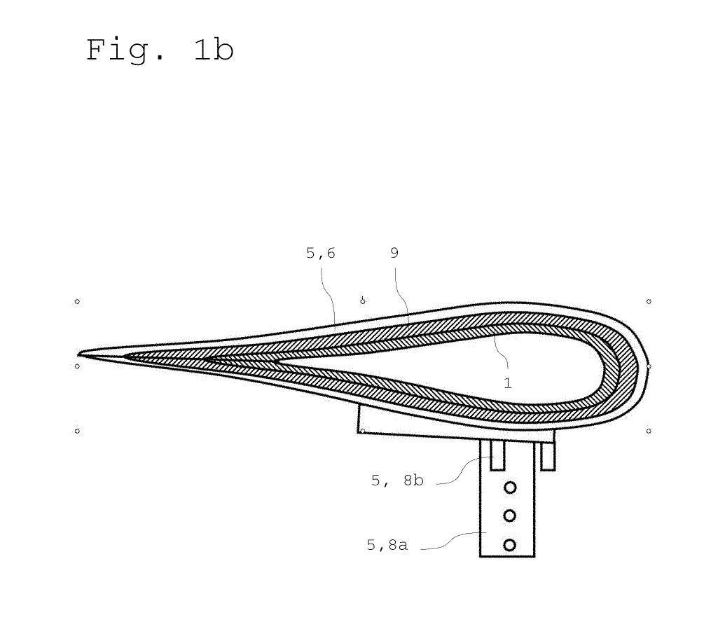

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

New systems for converting energy from flowing media are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIG. 1a shows the perspective view of a rotor blade connection component. The rotor blade connection component 5 in this case is made of galvanized steel. The profile of the rotor blade (not shown) is surrounded by an enclosing element 6. This creates a positive connection between rotor blade and rotor blade connection component 5. The rotor blade does not need to be drilled through. This makes it possible to avoid a weakening of the rotor blade at this area where stress levels are especially high.

The rotor blade connection component 5 can simply be pushed over the rotor blade with the enclosing element 6. The next section, by way of example, illustrates an adhesive bond with the rotor blade. Further details about the embodiment of this connection between rotor blade 1 and enclosing element 6 are provided in the description to FIG. 1b.

The rotor blade connection component comprises a connection element 8a for connection to a radial strut 2 (not shown here) and a connection element 8b for connection to a diagonal strut 3 (not shown here). Connection elements 8a, 8b are connected to enclosing element 6, preferably welded. Connection elements 8a, 8b are embodied here as screw connections 14. The screws (not shown) are guided through the struts (not shown) and a shear load is therefore exerted on them. These screw connections 14, may comprise any type of threaded fastener make the connection easy to assemble. At the same time, repair work is easy and inexpensive to perform. In further embodiments, the rotor blade connection component 5 may comprise a connection element 8a, 8b, and the radial struts 2 and the diagonal struts 3 may each be connected to the connection element 8a, 8b, by one or more screw connections 14.

The rotor blade connection component directs all forces introduced by means of the rotor blade 1 to the radial strut(s) 2 and or to the diagonal strut(s) 3.

FIG. 1b shows a section through a rotor blade 1 with rotor blade connection component. Rotor blade 1 is surrounded by the enclosing element 6 of the rotor blade connection component. Connection elements 8a, 8b serve as a connection with the radial struts 2 and diagonal struts 3 (not shown here). Between rotor blade 1 and enclosing element 6, a spacer element 9 is arranged. This spacer element 9 is disposed between the rotor blade 1 and enclosing element 6 so that the spacer element 9 fills the cavity or space between rotor blade 1 and enclosing element 6. Spacer element 9 strengthens rotor blade 1 in this area. Spacer element 9 can be created or formed by casting the cavity between rotor blade 1 and enclosing element 6 with a thermosetting polymer preferably containing epoxide groups, such as epoxy resin, or by inserting appropriate plastic strips. Enclosing element 6 can have a clamping fixture (not shown) that may for example apply contact pressure to rotor blade 1 by means of screws (not shown). The rotor blade 1 may be formed of a glass-fibre-reinforced plastic manufactured via extrusion moulding. In further embodiments, the fibres of the glass-fibre-reinforced plastic may be carbon fibres and that the plastic of the glass-fibre-reinforced plastic is a thermoplastic. A thermoplastic may comprise Acrylic, ABS, Nylon, PLA, Polybenzimidazole, Polycarbonate, Polyether sulfone, Polyoxymethylene, Polyetherether ketone, Polyetherimide, Polyethylene, Polyphenylene oxide, Polyphenylene sulphide, Polypropylene, Polystyrene, Polyvinyl chloride, Teflon, or any other thermoplastic.

Because the embodiment of enclosing element 6 is larger than the profile of rotor blade 1, it can be pushed over the latter easily and without damaging rotor blade 1. Production tolerances are easy to compensate for. In a similar way, and within certain limits, rotor blades of different sizes and different profiles can be connected by means of an enclosing element 6 to radial struts 2 and/or diagonal struts 3 to create a rotor. This can reduce costs and it also increases the variety of rotors in a cost-effective manner.

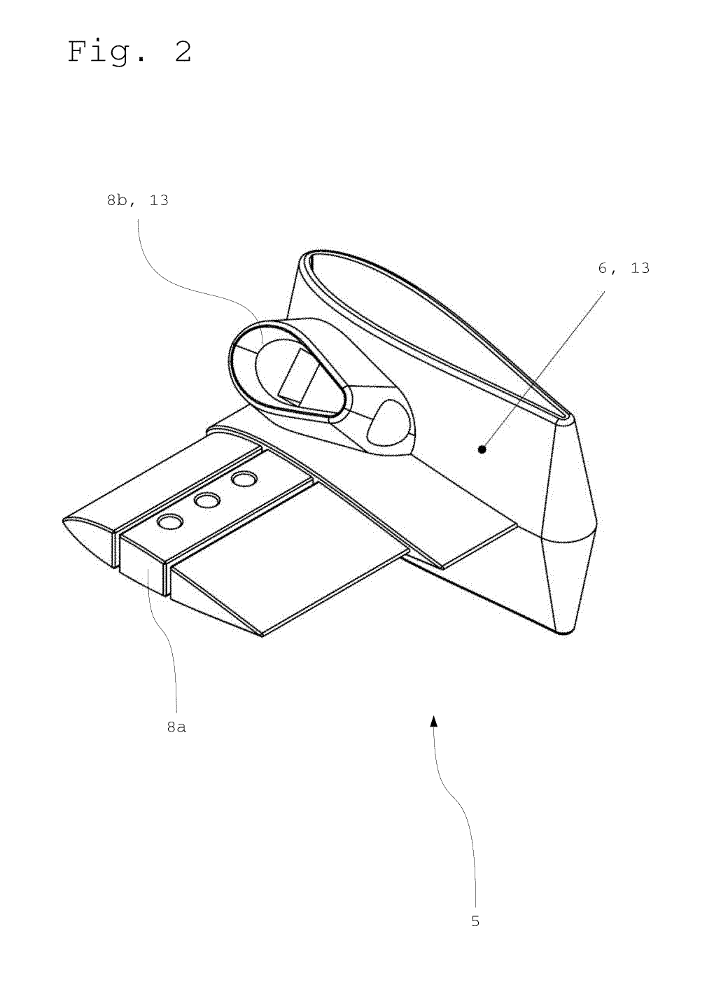

FIG. 2 illustrates a perspective view of rotor blade connection component known from FIG. 1a with a plastic enclosure 13. This plastic enclosure 13 can enclose the rotor blade connection component, thereby protecting it.

At the same time, an aerodynamic shape is created that is adapted to the profile of the rotor blade 1 and that prevents corresponding turbulence in the connection area of rotor blade 1. At the same time, an aesthetically appealing embodiment of the rotor blade connection is created. The connection element 8a for radial strut 2 (not shown here) takes here the form of an adapter element 8a that corresponds to the aerodynamically shaped profile of radial strut 2. The connection element 8b for diagonal strut 3 (not shown here) is adapted in a correspondingly aerodynamic way and is provided with a plastic enclosure 13. Bores are provided for the screw connections 14 (not shown here) that provide a connection with the radial strut 2 and/or the diagonal strut 3.

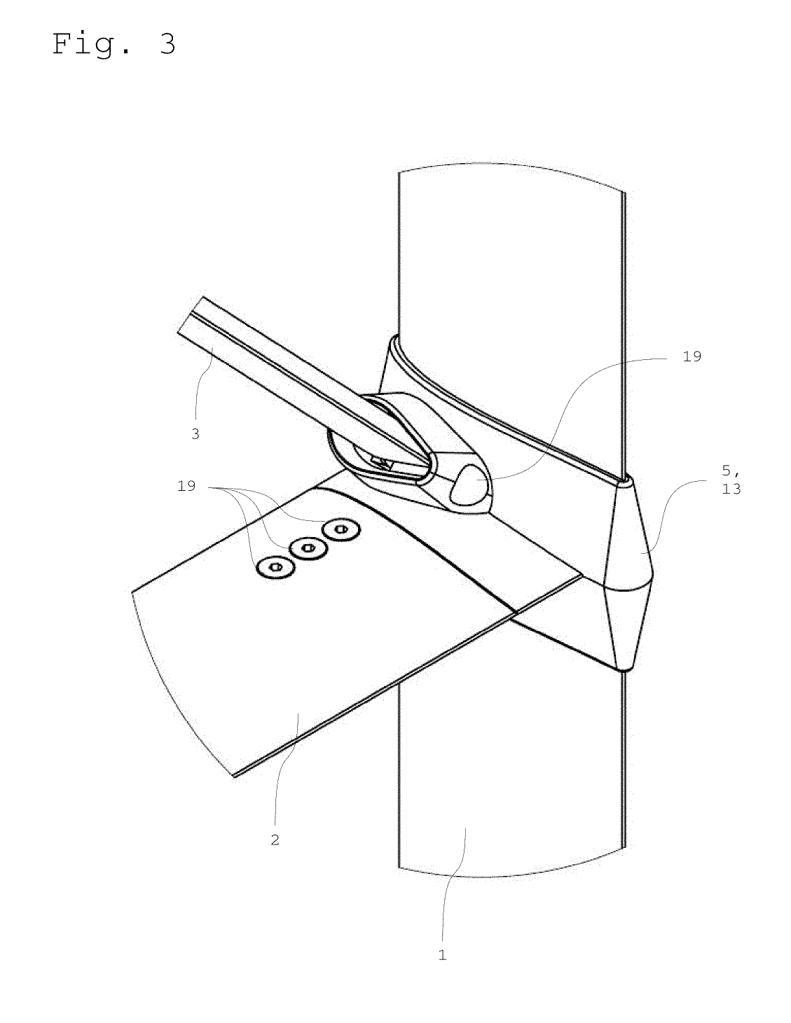

FIG. 3 shows a perspective view of a rotor blade connection component with plastic enclosure 13 known from FIGS. 1a and 2 as well as with rotor blade 1, radial strut 2 and diagonal strut 3.

By way of example, the plastic enclosure 13 can be produced using a corresponding multi-part casting mould that is positioned on the connection between rotor blade 1 and radial strut 2 and/or diagonal strut 3. Then, for the arrangement of screws, openings in the plastic enclosure 13 can be kept free with apertures that can be sealed with caps 19.

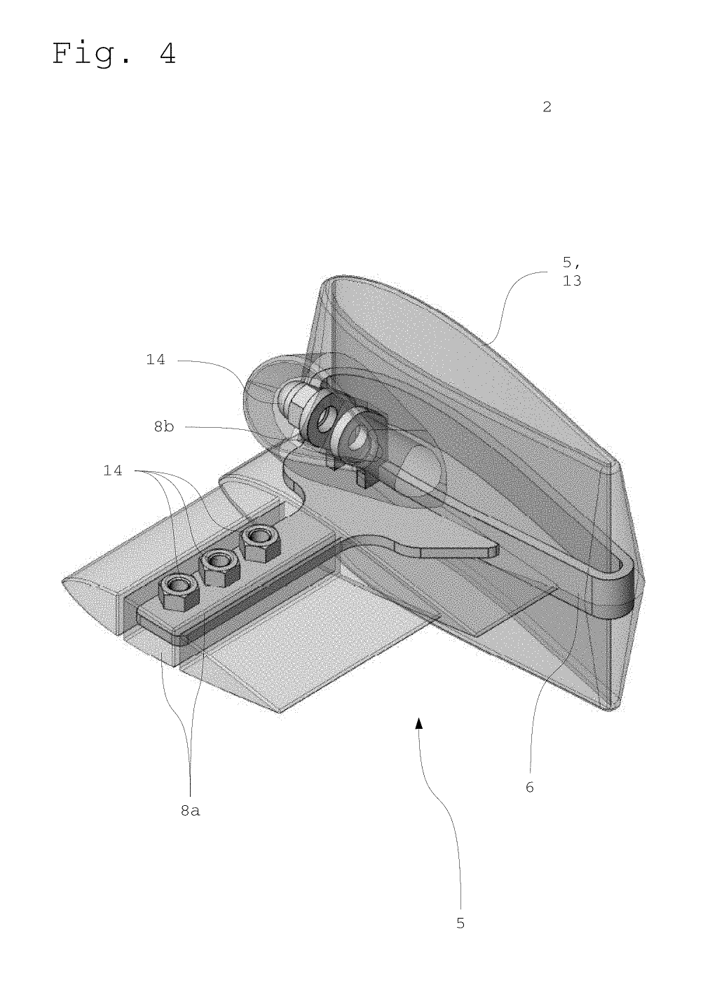

FIG. 4 shows the rotor blade connection component familiar from the previous Figures, this time in an assembly view. The enclosing element 6 with connection elements 8a, 8b, for radial strut 2 and/or diagonal strut 3 (not shown here) is contained in a plastic enclosure 13. This means that the rotor blade connection component is formed here by enclosing element 6, connection elements 8a, 8b, screw connections 14 and plastic enclosure 13.

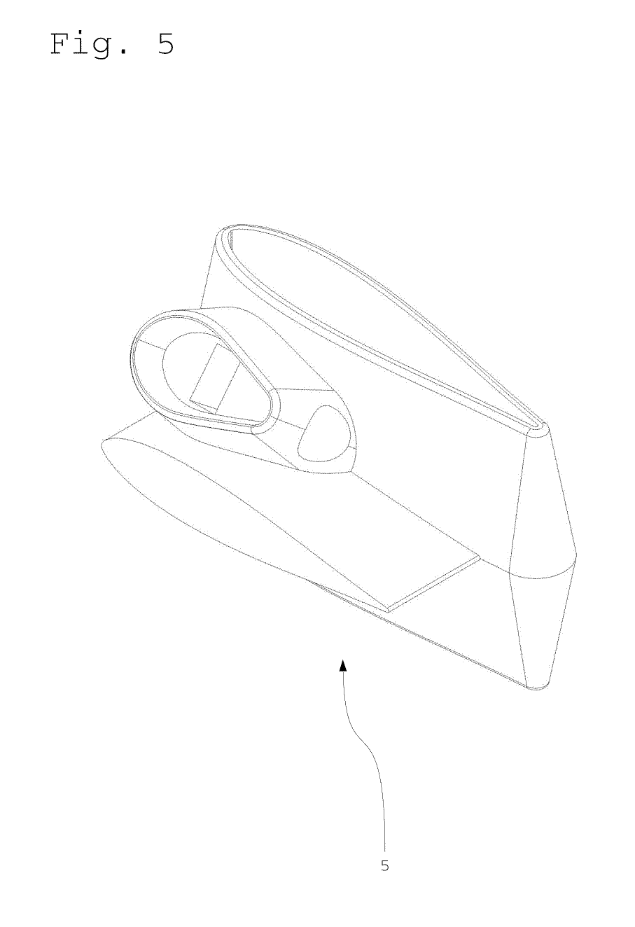

FIG. 5 shows an external perspective view of the rotor blade connection component 5 with plastic enclosure 13 familiar from previous Figures. The aerodynamic external contour is clearly visible here, also adapted to suit the profile of rotor blade 1 (not shown here), radial struts 2 and diagonal struts 3 (not shown here).

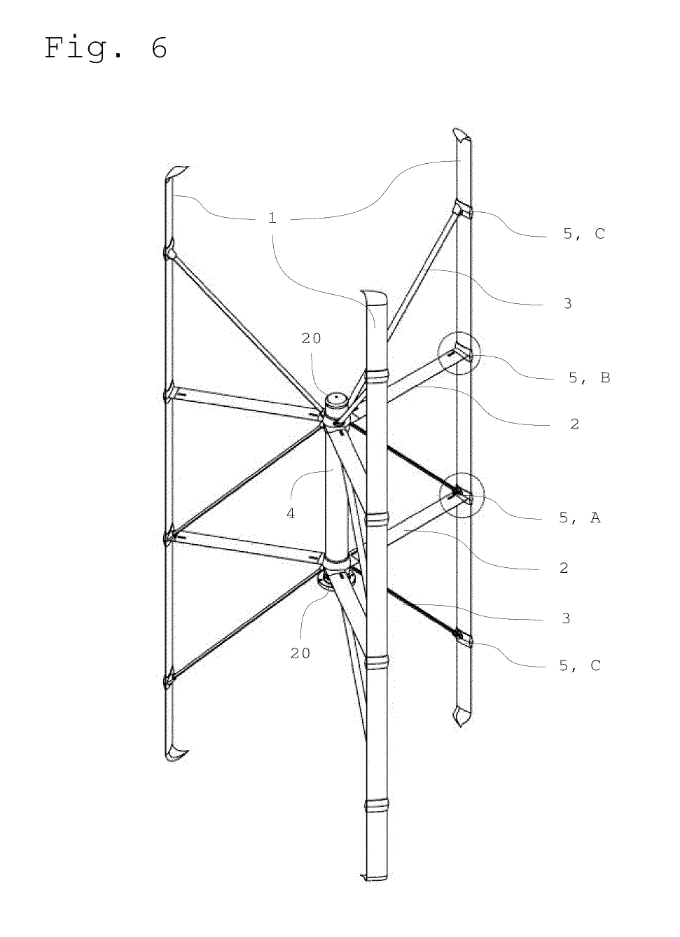

FIG. 6 show an H-Darrieus rotor with different embodiments of rotor blade connection components 5. These serve as a connection A on a rotor blade 1 with a radial strut 2 and diagonal strut 3, as a connection B of a rotor blade 1 with a radial strut 2 and/or as a connection C of a rotor blades 1 with a diagonal strut 3. Furthermore, the rotor blade connection component can embody a rotor blade 1 with a radial strut 2 and two diagonal struts 3. In a similar manner to the way the rotor blade connection components 5 are made, corresponding shaft connection components 20 can be arranged that provide a connection for shaft 4 with several radial struts 2 and/or diagonal struts 3.

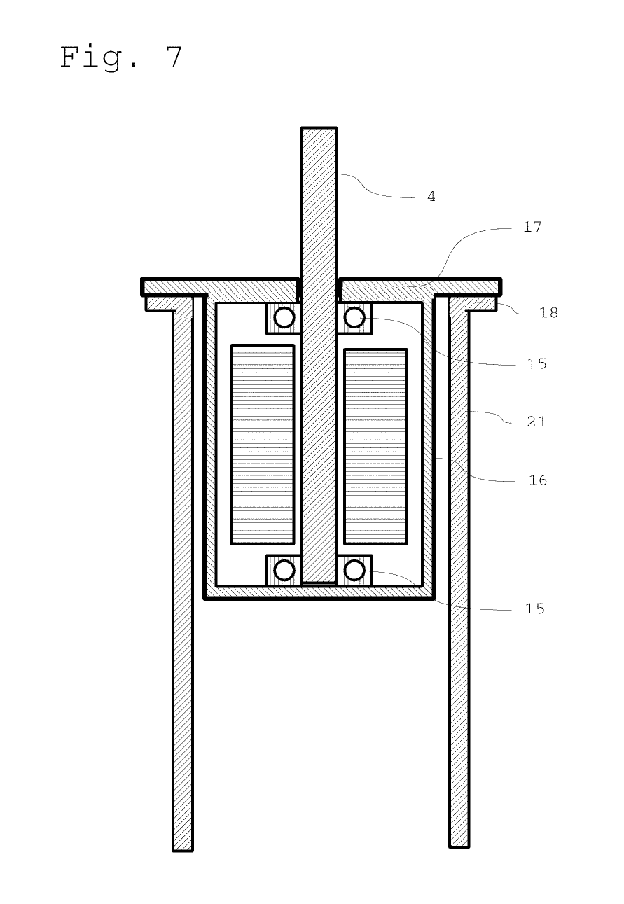

FIG. 7 shows a generator 16 with integrated rotor shaft mounting 15. The mounting of the rotor (not shown) is achieved through the use of correspondingly dimensioned bearings on the generator 16. This dissipates all forces on shaft 4 through the bearings of generator 16. Here, the generator 16 is arranged in tower 21 of the wind power system. To dissipate forces accordingly, generator 16 is equipped with a flange 18, whereby the flange 18 is connected by means of screw connections (not shown) to a tower flange 19 secured to the tower 21. Ultimately, this enables the forces introduced through rotor shaft 4 to be dissipated into the tower 21. Generator 16 is protected inside tower 21. The electrical lines can be installed inside the tower 21.

The rotor blades 1 are manufactured as a fibre-reinforced plastic profile using an injection moulding process. Preferably, carbon fibres embedded in a thermoplastic material are used as strengthening reinforcing fibres.

In some embodiments of the system, the rotor blades (1) are made of a glass-fibre-reinforced plastic section manufactured in an extrusion moulding process. In further embodiments, the fibres of the plastic section are carbon fibres and/or that the plastic is a thermoplastic material.

In some embodiments of the system, the rotor blades (1) are connected to a shaft (4) by means of radial struts (2) and/or by means of diagonal struts (3) and whereby a rotor blade connection component (5) is arranged to provide a connection between the respective rotor blade (1) and the radial struts (2) and/or diagonal struts (3), in which the rotor blade connection component (5) comprises an enclosing element (6) at least partially enclosing the profile of the rotor blade (1) and on the other the corresponding connection elements (8a, 8b) or the radial strut (2) and/or the diagonal strut (3). In further embodiments, the radial struts (2) and/or the diagonal struts (3) are connected to the connection element (8) by means of screw connections (14). In further embodiments, between the enclosing element (6) and the rotor blade (1) a cavity is formed or disposed which may be filled by a spacer element (9). In further embodiments, the spacer element (9) is incorporated by casting a material into the cavity. In further embodiments, a first positioning groove (10) is arranged or disposed in the enclosing element (6) to support the profile lug (11) and that a second positioning groove (12) is arranged to support the rear edge of the profile (13). In further embodiments, the radial struts (2) and/or the diagonal struts (3) are arranged as aerodynamic profiles. In further embodiments, the rotor blade connection component (5) in made of metal, in particular steel or aluminium. In further embodiments, the rotor blade connection component (5) and the rotor blade (1) as well as the radial struts (2) and/or the diagonal struts (3) in the connection area are in each case preferably enclosed in an enclosure (13) made of plastic and manufactured using a mould. In further embodiments, the bearing (15) for the rotor is integrated in a work machine (16) that needs to be driven. In further embodiments, the stator on the work machine (16) has a flange (17) connected to a corresponding tower flange (18).

In some embodiments of the system, the system may comprise a rotor blade 1, wherein the rotor blade is formed of a glass-fibre-reinforced plastic manufactured via extrusion molding. In further embodiments, the fibers of the glass-fibre-reinforced plastic are carbon fibers, and wherein the plastic of the glass-fibre-reinforced plastic is a thermoplastic. In further embodiments, the rotor blade may be connected to a shaft 4 by at least one radial strut 2 and at least one diagonal strut 3; a rotor blade connection component 5 may be configured to couple the rotor blade to the radial strut and to the diagonal strut; and/or the rotor blade connection component 5 may comprise an enclosing element 6 at least partially enclosing the profile of the rotor blade 1 and/or the rotor blade connection component 5 further comprises a radial strut 2 and/or a diagonal strut 3. In further embodiments, the rotor blade connection component 5 comprises a connection element 8, and the radial strut 2 and the diagonal strut 3 may each be connected to the connection element 8 by one or more screw connections 14. In further embodiments, a spacer element 9 may be disposed between the enclosing element 6 and the rotor blade 1. In further embodiments, the spacer element 9 may be formed by casting thermosetting polymer between the enclosing element 6 and the rotor blade 1. In further embodiments, a first positioning groove 10 may be disposed in the enclosing element 6, and a second positioning groove 12 may be disposed in the enclosing element 6. In further embodiments, the radial strut 2 may comprise an aerodynamic profile, and the diagonal strut 3 may comprise an aerodynamic profile. In further embodiments, the rotor blade connection component 5 may be made of metal. In further embodiments, the rotor blade connection component 5, portions of the rotor blade 1, the radial strut 2, and the diagonal strut 3 may be enclosed in an enclosure 13 made of plastic.

In some embodiments, the system may convert energy from flowing media with a rotor, the rotor comprising an H-Darrieus rotor, and a bearing 15 for the rotor 1 may be integrated in a driving work machine or generator. In further embodiments, the system may comprise a stator on the work machine which has a flange 17 connected to a corresponding tower flange 18.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A system for converting energy from flowing media with an H-Darrieus rotor, the system comprising a rotor blade, wherein the rotor blade is formed of a glass-fibre-reinforced plastic manufactured via extrusion molding.

2. The system of claim 1, wherein the fibers of the glass-fibre-reinforced plastic are carbon fibers, and wherein the plastic of the glass-fibre-reinforced plastic is a thermoplastic.

3. The system of claim 1, wherein the rotor blade is connected to a shaft by at least one radial strut and at least one diagonal strut, wherein a rotor blade connection component is configured to couple the rotor blade to the radial strut and to the diagonal strut, and wherein the rotor blade connection component comprises an enclosing element at least partially enclosing the profile of the rotor blade and the rotor blade connection component further comprises a component selected from the group consisting of: the radial strut and the diagonal strut.

4. The system of claim 3, wherein the rotor blade connection component comprises a connection element, and wherein the radial strut and the diagonal strut are each connected to the connection element by one or more screw connections.

5. The system of claim 3, wherein a spacer element is disposed between the enclosing element and the rotor blade.

6. The system of claim 5, wherein the spacer element is formed by casting thermosetting polymer between the enclosing element and the rotor blade.

7. The system of claim 3, wherein a first positioning groove is disposed in the enclosing element, and wherein a second positioning groove is disposed in the enclosing element.

8. The system of claim 3, wherein the radial strut comprises an aerodynamic profile, and wherein the diagonal strut comprises an aerodynamic profile.

9. The system of claim 3, wherein the rotor blade connection component is made of metal.

10. The system of claim 3, wherein the rotor blade connection component, portions of the rotor blade, the radial strut, and the diagonal strut are enclosed in an enclosure made of plastic.

11. A System for converting energy from flowing media with a rotor, the rotor comprising an H-Darrieus rotor, wherein a bearing for the rotor is integrated in a driving work machine.

12. The system of claim 11, the system comprising a stator on the work machine which has a flange connected to a corresponding tower flange.
